(19) United States
(12) Patent Application Publication
(10) Pub. No.: US 2026/0354342 A1
(43) Pub. Date: Nov. 12, 2026

(54) SYSTEM AND METHOD FOR TOWEL SYSTEM

(71) Applicant: Craig Supersad, Naples, FL (US)

(72) Inventor: Craig Supersad, Naples, FL (US)

(21) Appl. No.: 19/204,538

(22) Filed: May 11, 2025

(51) Int. Cl. A01K 13/00; A47K 10/02; F16B 47/00

(52) U.S. Cl. CPC A01K 13/001; A47K 10/02; F16B 47/006

(57) ABSTRACT

A system and method for pet towel device, including: a flexible absorbent body having a perimeter; a border positioned along at least a portion of the perimeter of the absorbent body; a plurality of elongated elastic threads, each having a first end connected to the border and a second end including a loop structure; and a plurality of suction cups, each suction cup including a protrusion configured to engage with a respective loop structure of the elongated elastic threads to removably secure the absorbent body to a surface.

### FIELD OF DISCLOSURE

This invention operates within the realm of towel systems, encompassing apparatus designed for both traditional use and floor mounted drying by using a series of connected suction cups.

### BACKGROUND

Frenetic Random Activity Periods (FRAPs), colloquially termed “zoomies,” manifest as abrupt, high-intensity energy discharges wherein canines engage in rapid locomotion characterized by accelerated running patterns, frequently accompanied by exaggerated physical movements and play-oriented behaviors. Such episodes may occur spontaneously across various temporal contexts, though they demonstrate notable frequency following bathing procedures or during states of excitement, contentment, or playfulness. While constituting normative behavioral manifestations that generally present minimal risk, zoomies may necessitate management strategies to mitigate potential environmental disruption.

Multiple etiological factors potentially underlie post-bathing zoomie manifestations in canines. Primary among these is the intrinsically stimulating nature of the bathing procedure itself, wherein water exposure, tactile sensations associated with cleansing manipulations, and deviation from established behavioral routines may collectively precipitate energetic discharge. Secondary contributory mechanisms include the psychological relief experienced upon release from bathing confinement, accompanied by instinctual water-removal behaviors and heightened sensory awareness of cleanliness and progressive drying. This liberation frequently catalyzes enhanced energy levels and play-seeking behaviors. Furthermore, the bathing process introduces novel sensory stimuli, including olfactory compounds from cleansing agents and the progressive transition from saturation to dryness, potentially triggering neurological pathways associated with excitement and spontaneous energy expression. While having the zoomies, the pets may not stay still, rolling up or moving the towel or getting the couch or other furniture wet. Thus exists the need for a towel that stays in place so the pet can dry off on their own.

### SUMMARY

In some aspects, the techniques described herein relate to a pet towel system, including: a flexible absorbent body having a perimeter; a border positioned along at least a portion of the perimeter of the absorbent body; a plurality of elongated elastic threads, each having a first end connected to the border and a second end including a loop structure; and a plurality of suction cups, each suction cup including a protrusion configured to engage with a respective loop structure of the elongated elastic threads to removably secure the absorbent body to a surface.

In some aspects, the techniques described herein relate to a pet towel system, wherein each suction cup of the plurality of suction cups includes: a concave suction face made of a flexible material.

In some aspects, the techniques described herein relate to a pet towel system, wherein each suction cup has a latch component configured to increase initial suction force and maintain tension on the suction cup to prevent gradual air seepage.

In some aspects, the techniques described herein relate to a pet towel system, wherein the absorbent body has a substantially rectangular shape with four corners, and wherein the elongated elastic threads extend outward from the four corners of the absorbent body.

In some aspects, the techniques described herein relate to a pet towel system, including: a flexible absorbent body having a perimeter, a plurality of elongated elastic threads, each having a fastening mechanism; and a plurality of suction cups, each of the plurality of suction cups including an attachment point to receive the fastening mechanism.

In some aspects, the techniques described herein relate to a pet towel system, wherein there are four of the plurality of suction cups positioned at corners of the flexible absorbent body.

In some aspects, the techniques described herein relate to a pet towel system, including: a flexible absorbent body having a perimeter, a plurality of elongated elastic threads, each having a fastening mechanism; and a plurality of stakes, each of the plurality of stakes including an attachment point to receive the fastening mechanism.

In some aspects, the techniques described herein relate to a pet towel system, wherein there are four of the plurality of stakes positioned at corners of the flexible absorbent body.

### BRIEF DESCRIPTION OF DRAWINGS

The present invention will be described by way of exemplary embodiments, but not limitations, illustrated in the accompanying drawings in which like references denote similar elements, and in which:

FIG. 1 shows an illustration of the towel system.

FIG. 2 shows an illustration of the suction cups of the towel system.

FIG. 3 shows an illustration of a second embodiment of towel system.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or another embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skills in the art to which this disclosure pertains.

The disclosed technology addresses the need for a towel system for absorbing moisture for a pet or animal while maintaining a stationary position such that the pet cannot move or roll up the towel. The towel system allows the user to choose between floor-mounted or traditional use for ultimate convenience.

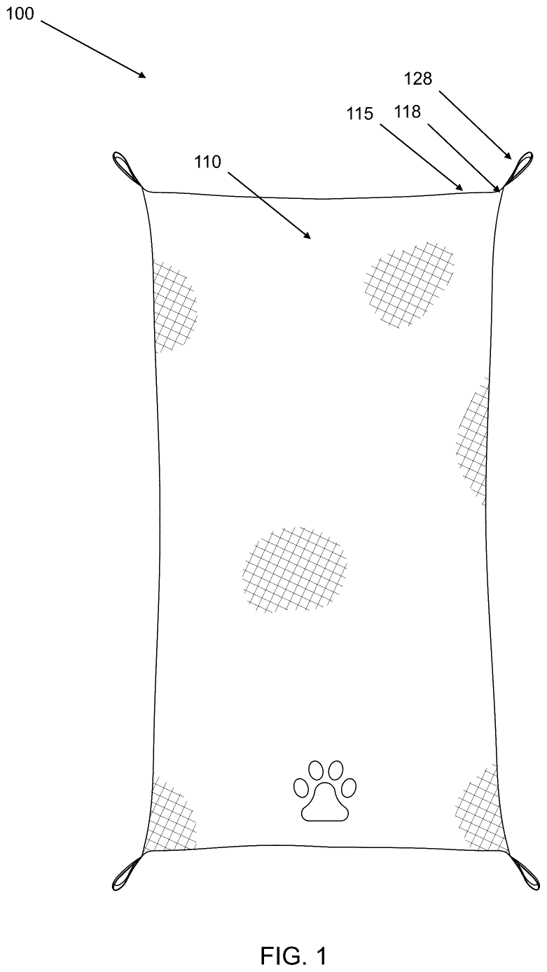

As illustrated in FIG. 1, towel system 100 may include a substantially rectangular fabric body having a first surface and an opposing second surface, body 110 being composed of a plurality of absorbent fibers arranged in a woven or non-woven configuration to create a three-dimensional matrix with enhanced moisture retention capabilities. However this is non-limiting, and body 110 may instead be any shape such as circular, square, or triangle, depending on the need and circumstances. In one exemplary embodiment, body 110 may be 1 51.5″ L×26″ W, but may be modified for any dimensions to accommodate pets of all sizes, ensuring a comfortable drying experience.

Body 110 may include a core layer having primarily hydrophilic natural fibers that exhibit rapid moisture absorption properties, and at least one exterior layer comprising a blend of natural and synthetic fibers engineered to enhance softness while maintaining structural integrity through repeated use and washing cycles. Body 110 may have tactile elements that encourage pets to rub against the towel or treat pockets to entice pets to stay at that location.

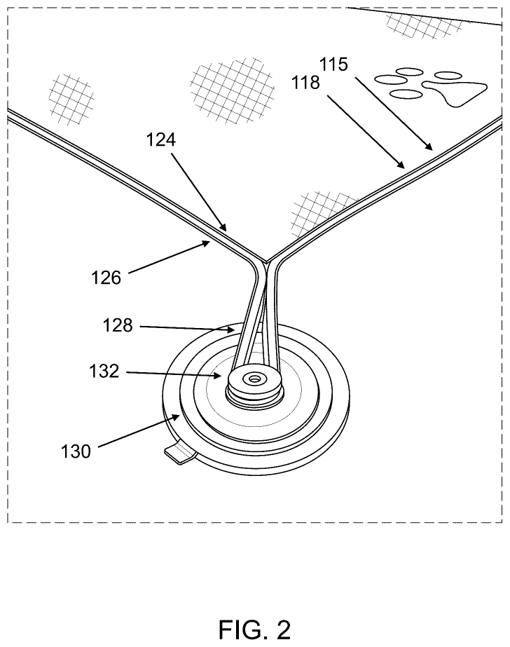

Along a perimeter of body 110 may be a border 115 made of a stretchable material that extends outward at the four corners of body 110 into a series of elongated elastic threads 118. Border 115 may have reinforced corners or edges to prevent wear at high-stress points. Elastic threads 118 may have a first end 124 directly connected to border 115 at the perimeter of body 110 or near border 115 and a second end 126 further away from body 110 and border 115, as illustrated in FIG. 2. Second ends 126 may each include an integrally formed loop structure 128 adapted to engage with and encircle a peg or similar protrusion 132 on suction cups 130 such that they may connect body 110 to suction cups 130.

Border 115 may be constructed from a resilient polymeric compound that provides significant tensile elongation while maintaining structural integrity during repeated stretching cycles. Each loop structure 128 may have sufficient internal diameter to accommodate standard-sized protrusions 132, and exhibits reinforced edge properties to prevent tearing or degradation at points of maximum stress. Upon stretching, the elastic body exerts a continuous retractive force that secures the loops firmly around their respective protrusions 132, thereby creating an adjustable connection between the anchor points while accommodating variable distances between protrusions 132.

As illustrated in FIG. 2, suction cups 130 may have a concave suction face 134 made of a flexible material. Concave suction face 134 may be facing downwards to a surface when positioned such that it is below protrusion 132. The shape of suction cup 130 allows air trapped between suction cup 130 and a surface the suction cup is attached to be expelled, creating a low-pressure area. As the air is expelled, the pressure inside suction cup 130 decreases, causing the higher atmospheric pressure outside the cup to push it against the surface, creating a seal. In further embodiments, a strap or other apparatus with a D-ring or other attachment point may be attached to the suction cup whereby threads 118 may be connected directly to the attachment point instead of the suction cup.

In some non-limiting embodiments, suction cup 130 may have a latch component to increase the initial suction force and maintain tension on the suction cup to prevent gradual air seepage. When engaged, the latch may pull the center of the suction cup slightly upward or inward, increasing the vacuum and strengthening the hold. To disengage, the latch includes a release tab or lever that, when activated, allows air to gradually flow back under the cup, equalizing pressure and breaking the suction.

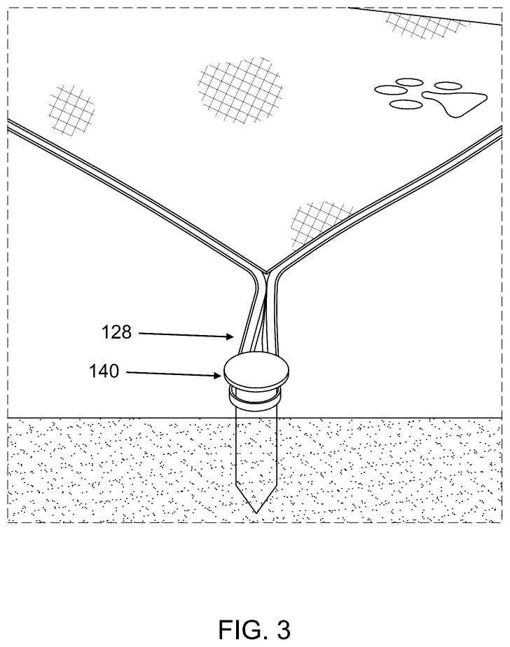

Suction cups 130 are designed to adhere best to smooth, clean, and oil-free surfaces like polished tile. They will not stick to textured surfaces, laminate, or wood with visible grain. To accommodate for this in further embodiments, suction cup 130 may be replaced by a stake 140 or other device capable of holding body 110 in place, as illustrated in FIG. 3. This may be useful for surfaces that are not capable of providing adequate suction such as a beach or the woods. In alternate embodiments other types of fastening mechanism may be used such as weights or magnets, depending on the surface. In further embodiments, the towel may be placed over a chair such as in a vehicle whereby it is held with a series of straps or other fasteners while it is draped over the chair.

During use, a user may secure the towel system 100 to the floor with the included detachable suction cups 130. This allows the pet to dry off naturally while freely moving without shifting or bunching the towel. Once done the user may remove the suction cups to transform it into a super-absorbent handheld towel for drying after baths, rainy walks, or outdoor playtime.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

1. A pet towel system, comprising: a flexible absorbent body having a perimeter; a border composed of a stretchable material and positioned along at least a portion of the perimeter of the absorbent body; a plurality of elongated elastic cords integrally formed as continuous extensions of the stretchable material of the border, each cord extending outward from a respective location along the border, each cord having a proximal end continuous with the border and a distal end including an integrally formed loop structure, wherein the border and the plurality of elongated elastic cords together constitute a unitary, one-piece body of the stretchable material; and a plurality of suction cups, each suction cup including a protrusion configured to engage with a respective loop structure of the elongated elastic cords to removably secure the absorbent body to a surface.

2. The pet towel system of claim 1, wherein each suction cup of the plurality of suction cups comprises: a concave suction face made of a flexible material.

3. The pet towel system of claim 1, wherein each suction cup has a latch component configured to increase initial suction force and maintain tension on the suction cup to prevent gradual air seepage.

4. The pet towel system of claim 1, wherein the absorbent body has a substantially rectangular shape with four corners, and wherein the elongated elastic cords extend outward from the four corners of the absorbent body.

5. A pet towel system, comprising: a flexible absorbent body having a perimeter; a border composed of a stretchable material and positioned along at least a portion of the perimeter of the absorbent body, a plurality of elongated elastic cords integrally formed as continuous extensions of the stretchable material of the border, each cord extending outward from a respective location along the border, each cord having a proximal end continuous with the border and a distal end including a loop structure, wherein the border and the plurality of elongated elastic cords together constitute a unitary, one-piece body of the stretchable material; and a plurality of suction cups, each of the plurality of suction cups including an attachment point configured to engage with the loop structure of a respective one of the elongated elastic cords to receive the loop structure.

6. The pet towel system of claim 5, wherein there are four of the plurality of suction cups positioned at corners of the flexible absorbent body.

7. A pet towel system, comprising: a flexible absorbent body having a perimeter; a border composed of a stretchable material and positioned along at least a portion of the perimeter of the absorbent body, a plurality of elongated elastic cords integrally formed as continuous extensions of the stretchable material of the border, each cord extending outward from a respective location along the border, each cord having a proximal end continuous with the border and a distal end including a loop structure configured to engage with a corresponding attachment point, wherein the border and the plurality of elongated elastic cords together constitute a unitary, one-piece body of the stretchable material; and a plurality of stakes configured to receive the loop structure of a respective one of the elongated elastic cords, wherein the plurality of elongated elastic cords are configured to apply tension between the absorbent body and the plurality of stakes.

8. The pet towel system of claim 7, wherein there are four of the plurality of stakes positioned at corners of the flexible absorbent body.
